(19) United States
(12) Patent Application Publication
(10) Pub. No.: US 2009/0284555 A1
(43) Pub. Date: Nov. 19, 2009

(54) SYSTEMS AND METHODS FOR GENERATING IMAGES USING RADIOMETRIC RESPONSE CHARACTERIZATIONS

(75) Inventors: Stephen B. Webb, Lexington, KY (US); Christopher Jaynes, Denver, CO (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: MERSIVE TECHNOLOGIES, INC., Lexington, KY (US)

(21) Appl. No.: 12/467,749

(22) Filed: May 18, 2009

Related U.S. Application Data
(60) Provisional application No. 61/053,902, filed on May 16, 2008.

(51) Int. Cl. G09G 5/10

(52) U.S. Cl. 345/690

(57) ABSTRACT

Particular embodiments relate generally to display systems and, more particularly, to display systems and methods for blending multiple images. A display system may include a first display source configured to generate a first image comprising illuminated points on a display surface, and a measurement device configured to measure an output energy value of the first image at output wavelengths for input values provided to the first display source. A normalized response function of the first display source corresponding to the measured output energy values for each output wavelength may be generated. A first response function that includes one or more of the normalized response functions of the first display source may be generated to derive corrected image input values corresponding to a desired output energy value at one or more illuminated points. The first display source may be controlled by applying the corrected input values.

### CROSS REFERENCE TO RELATED APPLICATIONS

This application claims the benefit of U.S. Provisional Application Ser. No. 61/053,902, filed on May 16, 2008, for Characterization of Display Radiometric Response For Seamless Projector Blending. The present application is also related to copending and commonly assigned U.S. patent application Ser. No. 12/425,896, filed on Apr. 17, 2009, for Multiple-Display Systems and Methods of Generating Multiple-Display Images, but does not claim priority thereto.

### BACKGROUND

Particular embodiments of the present disclosure relate generally to display systems and, more particularly, to display systems and methods of display systems that characterize a radiometric response of one or more display sources. Multi-projector displays often contain overlapping regions on a display surface where more than one display source, such as a projector, illuminates a single point. The overlap may be utilized to avoid gaps in the displayed image or artifacts induced by edge-matching the images generated by the different projectors. In the case where the display surface is curved, significant overlap may be necessary if gaps in the image are to be avoided. Additionally, full overlap between projectors can increase the perceived brightness of a display beyond the capabilities of a single projector.

Although projector overlap may be desired for these reasons, the overlapping region itself can induce unwanted display artifacts. The human visual system is very good at detecting consistent features, however faint, in a scene. For example straight edges, consistent color gradients, and corners are all detected by the human visual system easily and are observed with very little evidence. These features are all spatially varying functions of brightness that are consistent features in the scene. The human visual system is capable of detecting these “patterns” even with scant evidence. In particular, deriving a seamless image may be difficult if the projectors themselves exhibit unmodelled behavior that modifies the amount of light and its distribution, that illuminates the display surface. Furthermore the reflective characteristics of the display surface may respond differently to the different illumination characteristics of the projectors, thereby modifying the perceived light reflected from the display. If unaccounted for, these confounding factors can lead to perceptually apparent regions in the display where projectors overlap and traditional blending algorithms fail.

To achieve a substantially seamless blended image, the brightness and color within the overlapping regions should match other regions in the display (for example, regions illuminated by two projectors should appear as the same color and intensity of regions that are illuminated by a single projector). Algorithms may be used to compute the appropriate intensity to be rendered at each overlapping point to lead to the perception of a uniform intensity image. For example, an algorithm may derive an attenuated value to display at points in the overlapping region (e.g., ½ intensity at illuminated points on the display surface where two projectors overlap).

However, present display systems and methods may not effectively remove artifacts visible in the overlap region. Every projector produces a different radiometric response to stimulated inputs. Confounding factors that affect the observed color/intensity of a display produced by a projector may include, but are not limited to, internal signal processing, spectral response of the projector light source, characteristics of internal display elements (e.g., the actuation wavelength of the digital light projector (“DLP”) mirror), and the reflectance function of the display surface itself. These confounding factors may lead to perceptually apparent regions in the display where projectors overlap and traditional blending algorithms fail.

### SUMMARY

In one embodiment, a display system including a first display source and a measurement device is provided. The first display source may be configured to generate a first image comprising a plurality of illuminated points on a display surface, and the measurement device may be configured to measure an output energy value of the first image at the display surface at one or more output wavelengths for input values provided to the first display source. The display system may be programmed to generate a normalized response function of the first display source for each output wavelength that is measured. The normalized response functions of the first display source correspond to the measured output energy values for the provided input values. The display system is further programmed to generate a first response function that includes one or more of the normalized response functions of the first display source, and derive corrected image input values corresponding to a desired output energy value of the first display source at one or more illuminated points on the display surface. The first display source may be controlled to display the first image by applying the corrected input values derived from the first response function.

In another embodiment, a method of operating a display system is provided. According to the method, a first calibration image comprising a plurality of illuminated points on a display surface is generated by sequentially providing a first display source with a plurality of input values. Output energy values of the first calibration image are measured at the display surface at one or more output wavelengths for the input values provided to the first display source. A normalized response function of the first display source may be generated for each output wavelength based on the measured output energy values of the first display source. A first response function including one or more of the normalized response functions of the first display source may also be generated. The method may further include generating a first image at the display surface by providing corrected first image input values to the first display source. The corrected input values correspond to a desired output energy value of the first display source at one or more illuminated points of the first image based at least in part on a plurality of first image input values, the first response function and an attenuation value.

In yet another embodiment, a method of operating a display system is provided. The method includes generating a first and second image comprising a plurality of illuminated points on a display surface. At least a portion of the first image overlaps at least a portion of the second image in an overlap region of the multiple-display image such that each illuminated point within the overlap region of the multiple-display image comprises a first image contribution generated by the first display source and a second image contribution generated by the second display source. The method further includes transforming first image input values for illuminated points of the first image within the overlap region into output response values of the first display source, and transforming second image input values for illuminated points of the second image within the overlap region into output response values of the second display source. Corrected first and second image input values corresponding to the illuminated points of the first image may be derived from the output response values of the first and second display sources. The first and second display sources may be controlled to display the multiple-display image by applying the corrected first image input values and the corrected second image input values such that the first image contribution and the second image contribution combine to provide a desired output energy value at the illuminated points within the overlap region of the multiple-display image.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a schematic illustrating an exemplary display system according to one or more embodiments;

FIG. 2A illustrates an exemplary multiple-display image according to one or more embodiments;

FIG. 2B illustrates an exemplary multiple-display image according to one or more embodiments;

FIG. 2C illustrates an exemplary multiple-display image according to one or more embodiments;

FIG. 2D illustrates an exemplary multiple-display image according to one or more embodiments;

FIG. 2E illustrates an exemplary multiple-display image according to one or more embodiments; and

FIG. 3 is a schematic illustrating an exemplary display system according to one or more embodiments.

### DETAILED DESCRIPTION

Referring to the drawings, embodiments may improve intensity or color blending in overlap regions of an image generated by multiple display sources by taking into account a radiometric response function resulting from complex confounding display factors, which may include internal characteristics of each display source or external characteristics such as display surface reflectance. Embodiments may determine a response function for each display source by measuring an output energy of the display source at the display surface for a plurality of input values. The measured output energy values may then be used to generate a response function. When blending two or more images produced by multiple display sources, the display system may be programmed to take into account the response function of each display source when assigning input values to the displays to substantially achieve the desired output response at the illuminated points within the overlap region. Therefore, the output behavior of the display source may be known for any given color. In this manner, multiple images may be blended substantially free from artifacts such as banding. Although some embodiments described herein are described in the context of multiple-display systems, embodiments of the present disclosure are not limited thereto. For example, the use of response functions may be utilized to achieve a single-display image having particular characteristics, such as desired brightness and color characteristics.

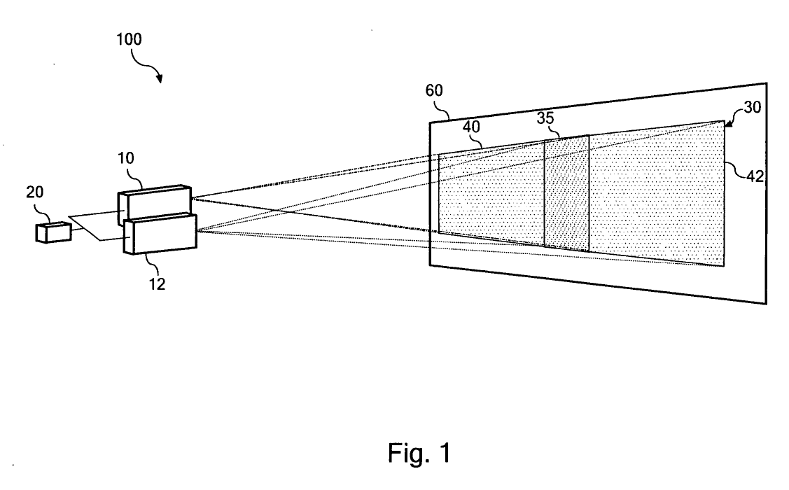

Referring to FIG. 1, an exemplary display system is illustrated. In the embodiment, a first and second display source 10, 12 projects a first and second image 40, 42 onto a display surface 60 (e.g., a screen or a wall) to form a multiple-display image 30 comprising a plurality of illuminated points. The illuminated points of the multiple-display image 30 are defined as illuminated areas on the display surface 60 that are generated by image contributions of the display sources 10, 12. The first and second display sources 10, 12 may be projectors configured for emission of optical data to generate moving and/or static images. In some embodiments, the display sources 10, 12 may be controlled by a system controller 20, which may be a computer or other dedicated hardware. In other embodiments, the display system may not comprise a system controller 20. For example, one of the display sources 10, 12 may operate as a master and the remaining display source or sources as a slave or slaves.

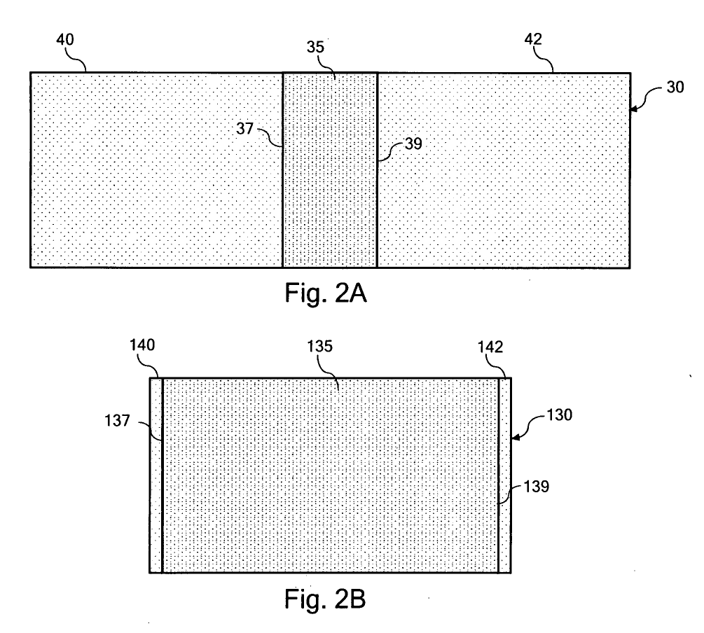

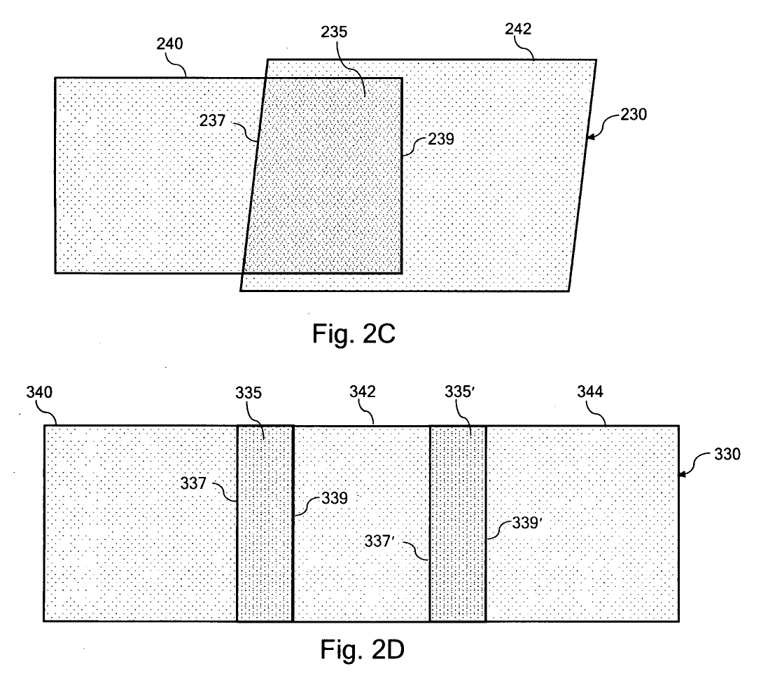

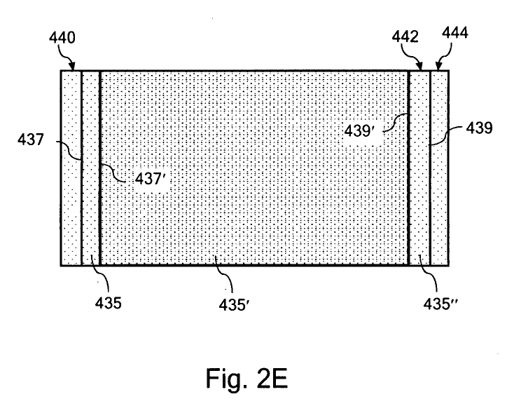

Referring now to FIGS. 1-2E, the first and second images 40, 42 may overlap one another in an overlap region 35. The overlap region 35 is defined in part by the termination of the first image 40 at border 39 and the termination of the second image 42 at border 37. The overlapping images may be arranged in a variety of configurations. FIG. 2A illustrates a multiple-display image 30 having a relatively narrow overlap region 35, while the multiple-display image 130 illustrated in FIG. 2B has an overlap region 135 that is a significant portion of the total image 130. FIG. 2C illustrates a multiple-display image 230 having an irregularly shaped second image 242 that defines an irregularly shaped overlap region 235. It will be understood that the multiple-display image may comprise more than two overlapping images in display systems having more than two display sources. For example, FIG. 2D illustrates a multiple-display image having three overlapping images 340, 342 and 344 that define two overlap regions 335 and 335′. FIG. 2E illustrates a multiple-display image generated by three display sources (440, 442 and 446) having an overlap region 435′ that contains contributions from the three display sources and two overlap regions 435 and 435″ that contain contributions from two out of the three display sources.

The first and second display sources 10, 12 may be arranged such that the illuminated points generated by the first display source 10 substantially overlap the corresponding illuminated points generated by the second display source 12 within the overlap region 35. Each point P(x,y) within the overlap region may be illuminated by a first image contribution provided by the first display source 10 and a second image contribution provided by the second display source 12. The image contribution comprises radiometric parameters such as intensity (i.e., brightness) and color value. Color values may include a red, blue and/or green color value. Embodiments of the present disclosure may be used to blend the radiometric parameters of a variety of color spaces, such as YCbCr, for example. Display sources of some embodiments may also be configured to generate multi-spectral imagery.

To generate a multiple-display image that has minimal visible artifacts, the radiometric parameters of the first and second contributions for each illuminated point within the overlap region 35 should be attenuated so that the total radiometric parameter value O (e.g., an intensity value I) of the illuminated points within the overlap region 35 match the illuminated points outside of the overlap region 35 that have a similar total radiometric parameter value O. For example, if each display source 10, 12 generating the multiple-display image 30 illustrated in FIGS. 1 and 2 were to produce the total intensity value I for each illuminated point within the overlap region, the overlap region 35 would be approximately twice as bright as the portions of the multiple-display image 30 that are outside of the overlap region 35.

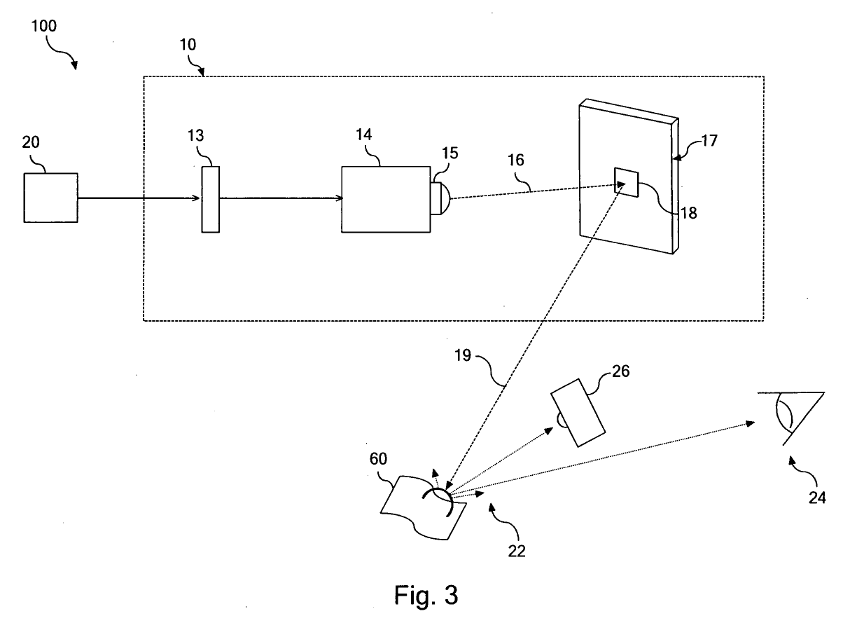

Referring to FIG. 3, the display system 100 may comprise several components that may introduce potentially complex nonlinearities into the output of the display sources. These nonlinearities may introduce artifacts into the multiple-display image. FIG. 3 demonstrates the potential complexities in modeling the expected output energy and frequency distribution function from the input RGB values. As described above, a display system 100 may comprise a controller 20 and a display source 10. For simplicity, only one display source 10 is illustrated in FIG. 3. Projected images are typically a function of input values R,G,B at a given pixel (i,j) that correspond to an illuminated point on the display surface 60. The input values may be provided in the form of an input signal by the system controller 20 to the display source 10 via a display input 13. In other embodiments, the system controller 20 may be an integral component with the display source. Although display sources described herein are described as being stimulated with three color values corresponding to red, green, and blue (RGB), it will be understood that other embodiments may be driven by other digital input signals such as YUV and input signals that consist of more (or less) than three values.

The observed color/intensity of a display may be related to the input R, G, B color values via a series confounding factors both internal and external to the display source 10. A light engine 14 may convert the digital signal provided by the display input into an analog signal by the use of signal processing. Because every display source may possess different digital to analog gain functions in the display source electronics, the output response of every display source may be different. Similarly, physical characteristics of an illumination source 15 that produces light 16 may yield an output that is different from one display source to the next. In the illustrated embodiment, the illumination source 15 illuminates a DLP element 17 comprising a plurality of controllable mirrors (e.g., mirror 18) that correspond to the pixels of the desired image. The DLP element 17 may be actuated to reflect the light 19 to control the grayscale levels of illuminated points on the display surface 60. Further, each display surface (and locations of a display surface) may have a different reflectance function as indicated by the reflected light 22 in FIG. 3. The different reflectance functions also contribute to the nonlinear output response of a display source. The actuation frequency of the DLP mirrors 18 may also contribute to the nonlinearity of the output response. It will be understood that embodiments may also utilize display technologies that do not utilize a DLP element.

Without some model of this transfer function, blending overlapping display sources may present visible artifacts in the displayed image. Consider a blending approach of two display sources that overlap at point (x,y) on a display surface described above. If we assume the observed value at the overlapping point is to be [r₀ g₀ b₀]^{T}, then the corresponding input values for each of the two display sources might be ([r₁ g₁ b₁])/2 and ([r₂ g₂ b₂])/2. This blending algorithm is intended to yield the correct intensity value at a display surface point where two display sources overlap by driving the display source with one-half of the intended output value for each display source. Ideally, at the overlap point, the display sources will “sum” to yield the intended observed intensity ([r₁ g₁ b₁])/2+([r₂ g₂ b₂])/2=[r₀ g₀ b₀]^{T}.

However, the unknown radiometric response function due to the factors described above may affect the input values so that they no longer sum to the intended observed color and intensity. The unknown radiometric response functions of the two display sources can independently, or in a correlated fashion, manipulate the output intensity of color values to produce undesirable blending artifacts.

Embodiments described herein may characterize the potentially complex radiometric response function influenced by the factors illustrated in FIG. 3 by modeling an observed output energy value at the display surface with a response function that encompasses these factors (and others). As described below, the resulting response function or functions may then be utilized to determine attenuation values to be applied to each display source such that each illuminated point in an overlap region of a multiple-display image is substantially equal to a desired output energy value (e.g., intensity or color value). In this manner, the impact of the unknown display radiometric response function may be estimated prior to blending the two or more images of the multiple-display image.

To generate a radiometric response function for a particular display source, embodiments may observe the output behavior of the display source (or sources) with a measurement device at many different input values and derive the complex function that may encompass a variety of factors and sources of distortion. This measurement captures not only characteristics internal to the display source 10, but also external characteristics of the display system environment, such as display surface reflectance. Some embodiments measure the observed intensities at particular wavelengths when the display is stimulated via different R G B digital inputs. Other embodiments may drive the display with other digital signals, such as Y U V input values.

Capturing the output energy values and generating the response function will now be described. In one embodiment, a measurement device 26 (FIG. 3) is placed in front of the display surface in order to capture the response function for the display source 10 at the display source 60 for a particular output wavelength (i.e., color). This may be accomplished via a radiometer, a digital camera with appropriate color filters, or other devices. The measurement device may be positioned so it may measure a region on the display surface 60. A measurement algorithm may be used to sequentially input into the display device 10 all possible [R G B] values (for example (0,0,0), (0,0,1), . . . (0,0,255), (0,1,255)), or some subset of those values (e.g., increments of 5 for R, G and B). Each set of input values instructs the display source 10 to display a solid calibration image on the display surface 60.

The measurement device 26 is configured to capture the calibration image at the display surface 60 for each set of input values. An output energy value may then be obtained from the captured calibration image and recorded. Each measurement may yield an output energy value, I_{w}, where I is some intensity value measured on the sensor of the measurement device 26, and w is the range of wavelengths being measured. In some embodiments, the captured image for each set of input values may be processed prior to recording an output energy value to ensure an accurate measurement of the observed intensity for the corresponding input values. Such processing may include, for example, image smoothing, high-dynamic range processing, or other digital image processing algorithms. The process of sequentially inputting input values into the display source 10 is repeated for all desired output wavelengths that will be measured. The output energy values may be measured at red, green, blue wavelengths but may also be measured at any set of color wavelengths that need to be modeled (for example, the tri-stimulus frequencies and distributions of the human eye can be used).

For example, the measurement algorithm may be programmed to provide the display source with all possible (or a subset) [R G B] values while the measurement device 26 is filtered to detect wavelengths centered at a particular red wavelength. Once the output energy values for the red wavelength (I_{R}) are captured and recorded, a filter on the measurement device 26 may be changed to detect wavelengths centered at a particular green wavelength and the [R G B] input values may again be sequentially provided to the display source 10 and output energy values for the green wavelength (I_{G}) may be captured and recorded. This process is repeated to obtain the output energy values for the blue wavelength (I_{B}). This yields a mapping for all input values to output intensities at that particular wavelength range, I_{w}=f_{w}(R G B). The function captures the amount of energy at wavelength w, or the amount of energy over some range centered on w, that is observed when particular [R G B] input values are inputted into the display source 10. It is noted that the measurement device 26 may also be configured to capture and represent the output energy values of the display source 10 in other ways such as a YUV camera that records the intensity and chromatic values for given input values. In this case, the method may not be different but the functions recovered directly map input signals to the measured output space. It will be understood that embodiments that the use a radiometer for the measurement device 26 do not need to a filter change to detect the output energy values at the particular wavelengths or wavelength ranges. It will also be understood that each function may be captured from the display source 10 independently and in sequence (e.g., by changing the filter on the camera at each stage) or all at once if the measurement device 26 is capable of correctly measuring the output energy values at the output wavelengths at the same time.

Once the output values for the particular output wavelengths are recorded, the resulting data may be characterized by a function or stored in a look-up table. In embodiments in which R G B output energy values are recorded, the result may be a set of functions fᵣ, f_{g}, f_{b}.

The measurement process described above results in a set of measurements that are in the units of the measurement device 26 (for example 0,255 intensity levels in a digital camera). Additionally, the measurements may be affected by the distance of the measurement device 26 to the display. For example, measured output energy values may be higher for a measurement device 26 that is placed closer to the display surface 60. Therefore, to directly compare the measurements made, the measurements should be normalized such that the resulting functions map input [R G B] values to an output scale that is unitless and represents the relative amount of energy observed for different input signals.

Finally, the normalized response functions for each of the different measured wavelengths may be combined into a single function that takes R, G, B as input and yields an expected output response value for each measured wavelength. In other words, the response function maps an input color vector to an output response, [r′ g′ b′]^{T}=f(R,G,B)_{i,j}. This resulting function may be stored either as a direct lookup table, some interpolation of the measured output energy values for the given input values, or as some parametric function derived from the measurements. Because the resulting response function is three dimensional, embodiments may accurately model display sources that alter the amount of one color emitted as the amount of one or more other colors are increased or decreased.

Once a radiometric response function is created and available to a given display source 10, 12, it may be used to derive corrected input values for a desired observed intensity level. The desired output energy value of these illuminated points within the overlap region should match similar illuminated points that are outside of the overlap region to provide for substantially seamless image blending. In a multiple-display image, each illuminated point within an overlap region has a desired output energy value, such as an intensity level. Although the response function may assist in blending multiple images together, it may also be used for a number of other applications that require accurate relative energy from a single display source, or multiple display sources that do not provide overlapping images.

For example, if a projector P has a response function f_{P}(R G B), and is currently being stimulated by input color (R G B)=(100 100 100), and the goal is to display some attenuation of the output energy value for red, green, and blue using an attenuation factor a of the current intensity, the response function may be used to derive the correct input color [R G B]^{T}. This may be expressed by:

$${[ \begin{matrix}R & G & B\end{matrix} ]}_{input}^{T} = {f}_{p}^{- 1} ( \frac{{f}_{p} ( \begin{matrix}R & G & B\end{matrix} )}{a} ) , \qquad Eq . ( 1 )$$

Embodiments may utilize radiometric response functions to correctly blend two display sources having potentially complex, and different, underlying response functions. The display system may correctly compute what each display source should project in the overlap regions so that they are correctly attenuated and blended together. First, input values corresponding to the illuminated points within the overlap region are transformed to the output response values of the display source by using the response function of Equation 1. This yields the measured output responses of the display source for the input values. Next, to compute a correct percentage of energy in the radiometrically corrected space, the output response value is then divided by the attenuation value. For example, in a display system having two display sources producing an image with an overlap region such as the display system illustrated in FIG. 1, the attenuation factor may be two. In a single display source system, the attenuation factor may be one, or some other value. Finally, the inverse of the radiometric function fₚ⁻¹, is applied to the attenuated output response value to take the ½ energy response of the display source and derive what input values will lead to that output level. The inverse of the radiometric function may be derived using mathematic techniques know in the art as well as currently unknown techniques.

By way of example and not limitation, assume that two display sources (e.g., first display source 10 and second display source 12) project images that overlap one another, and it is desired to determine what input values to provide to the display sources 10 and 12 so that at an overlapping illuminated point, the two display sources 10, 12 sum to the intended R, G, and B values. Also assume that the output energy values of the first display source 10 are manipulated via the processes described in the introduction by the following exemplary functions:

f_{R}(R G B)=R^{1,4}, Eq. (2);

f_{G}(R G B)=¾*G, Eq. (3); and

f_{B}(R G B)=B^{0,9}+R^{0,1}, Eq. (4).

If a red (R) value of 100 and a red value of 50 is provided to the first display source 10, the red 100 input will yield an image that is approximately 2.63 times as bright as the image generated by the display when a red value of 50 is inputted into the display. Therefore computing the intended values without first correcting for the radiometric characteristics of the display source, in this case, will lead to significantly more red frequencies in the overlap region than intended. Furthermore, in the above example, green input values to green output values are linearly transformed by ¾, while the observed blue colors are nonlinearly related to both the input blue and red values. Not addressing these functions and relationships between color values when computing what input value will yield an appropriate attenuated output response may lead to error. It will be understood that the above exemplary response functions are for illustrative purposes only.

The second display source 12 may have a response function that is different from those of the first display source (e.g., Eq. 2-4). For example, if a green (G) output of 100 is desired for a particular illuminated point in the overlap region, 50% energy from the first and second display sources 10, 12 may not be effectuated by an input value of 50 into each display source. The response functions for both display sources 10, 12 may require a corrected input value of 62 for the first display 10, for example, and 58 for the second display 12 to achieve the desired intensity for the particular illuminated point. These inputs, rather than 50 for the first display source 10 and 50 for the second display source 12, may result in displaying 50% of 100 at the display surface 60.

The captured radiometric response functions described above may be stored and made accessible to the display controller 20 or other electronics. The response function may be stored in accelerated graphics hardware such that the display system may apply Equation 1 to all color pixels as they are rendered in a graphics module. The graphics module may be located in the system controller 20, or in a display source 10, 12. If the functions are 3-dimensional, the RGB response function may be stored as 3D table (i.e., a 3D texture map). The inverse 3D texture map may be derived using traditional function inversion techniques or may be built through a procedure that interpolates a new table from the existing 3D texture map. Once both 3D tables have been constructed, they may be stored on a graphics card and then applied to the incoming color values using programmable graphics hardware that implements Equation 1.

Embodiments described herein may be used to compute the appropriate attenuation values in overlapping images for multi-projector (and other) displays where attenuation values can be derived via a number of known (or not yet known) techniques. Additionally, embodiments may be used whenever a display is required to derive an input signal that will lead to an output energy value that is some percentage of other inputs on the same device. Embodiments of the response functions described herein may also be utilized in conjunction with other blending techniques to seamlessly blend multiple images, such as introducing a random or pseudo-random element into the blending function to further remove visual artifacts from the overlap region as disclosed in U.S. patent application Ser. No. 12/425,896 entitled Multiple-Display Systems and Methods of Generating Multiple-Display Images, which is incorporated herein by reference in its entirety. Embodiments may also be utilized with other techniques that estimate and alter portions of a radiometric response function for a display source. For example, a display source may have user-selectable options such as the removal of a gamma value. A response function for an operational mode of the display source such as the removal of a gamma value may be generated and utilized to increase the accuracy of the blending of multiple display sources by characterizing a display source output in such an operational mode.

Embodiments of the present disclosure may enable substantially seamless blending in overlap regions of an image generated by multiple display sources by utilizing a radiometric response function for one or more display sources generating a multiple-display image. Embodiments may determine a response function for each display source by measuring an output energy value of the display source at a display surface for a plurality of input values at one or more output wavelengths. The measured output energy values may then be used to generate a normalized response function for each output wavelength. When blending two or more images produced by multiple display sources, the display system may be programmed to apply corrected input values to the display sources in accordance with the response functions to achieve the desired output response at the illuminated points within the overlap region. Therefore, blended images of a multiple-display image may be substantially free from visual artifacts in the overlap region.

It is noted that terms like “commonly,” and “typically,” if utilized herein, should not be read to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the terms “approximately” and “substantially” are utilized herein to represent the inherent degree of uncertainty that may be attributed to any quantitative comparison, value, measurement, or other representation. The terms “approximately” and “substantially” are also utilized herein to represent the degree by which a quantitative representation may vary from a stated reference without resulting in a change in the basic function of the subject matter at issue.

It is noted that recitations herein of a component of the present invention being “configured” or “programmed” in a particular way, “configured” or “programmed” to embody a particular property, or function in a particular manner, are structural recitations as opposed to recitations of intended use. More specifically, the references herein to the manner in which a component is “configured” or “programmed” denotes an existing physical condition of the component and, as such, is to be taken as a definite recitation of the structural characteristics of the component.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A display system comprising a first display source and a measurement device, wherein:
the first display source is configured to generate a first image comprising a plurality of illuminated points on a display surface;
the measurement device is configured to measure an output energy value of the first image at the display surface at one or more output wavelengths for input values provided to the first display source; and
the display system is programmed to:
generate a normalized response function of the first display source for each output wavelength, wherein the normalized response functions of the first display source correspond to the measured output energy values for the provided input values;
generate and store within a memory location a first response function comprising one or more of the normalized response functions of the first display source;
derive corrected image input values corresponding to a desired output energy value of the first display source at one or more illuminated points on the display surface based at least in part on the first response function; and
control the first display source to display the first image by applying the corrected input values derived from the first response function.

2. A display system as claimed in claim 1 wherein:
the display system further comprises a second display source;
the second display source is configured to generate a second image comprising a plurality of illuminated points on the display surface, thereby generating a multiple-display image comprising the first and second images;
the first display source and the second display source are configured such that at least a portion of the first image overlaps at least a portion of the second image in an overlap region of the multiple-display image, wherein each illuminated point within the overlap region of the multiple-display image comprises a first image contribution and a second image contribution;
the measurement device is configured to capture an output energy value of the second image at the display surface at one or more output wavelengths for input values provided to the second display source; and
the display system is programmed to:
generate a normalized response function of the second display source for each output wavelength, wherein the normalized response functions of the second display source correspond to the captured output energy values for the provided input values;
generate and store within a memory location a second response function comprising one or more normalized response functions of the second display source; and
derive corrected input values for the first and second display sources based at least in part on the first and second response functions and an attenuation value such that the first image contribution and the second image contribution combine to provide a desired output energy value at each illuminated point within the overlap region of the multiple-display image; and
control the first and second display sources to display the multiple-display image by applying the corrected input values derived from the first and second response functions.

3. A display system as claimed in claim 2 wherein for one or more illuminated points of the multiple-display image, the display system is further programmed to:
transform a plurality of first image input values into corresponding output response values of the first display source in accordance with the first response function;
transform a plurality of second image input values into corresponding output response values of the second display source in accordance with the second response function;
apply the attenuation value to the output response values of the first and second display sources;
derive the corrected input values of the first display source using the attenuated output response values of the first display source by applying an inverse first response function; and
derive the corrected input values of the second display source using the attenuated output response values of the second display source by applying an inverse second response function.

4. A display system as claimed in claim 2 wherein the display system comprises one or more additional display sources and the display system is configured such that one or more illuminated points within the multiple-display image are illuminated by one or more of the display sources.

5. A display system as claimed in claim 1 wherein each output wavelength comprises a range of wavelengths centered on a base wavelength.

6. A display system as claimed in claim 1 wherein the measurement device is configured to capture the output energy values at a first output wavelength, a second output wavelength and a third output wavelength.

7. A display system as claimed in claim 6 wherein:
the first output wavelength comprises a range of wavelengths centered on a red base wavelength;
the second output wavelength comprises a range of wavelengths centered on a green base wavelength; and
the third output wavelength comprises a range of wavelengths centered on a blue base wavelength.

8. A display system as claimed in claim 1 wherein the measurement device comprises a CCD camera or a radiometer.

9. A display system as claimed in claim 1 wherein the measurement device comprises a filter for each output wavelength such that each filter allows radiation within a range of wavelengths to reach the measurement device.

10. A display system as claimed in claim 1 wherein:
the display system further comprises a graphics module;
the response function of the first display source comprises a three dimensional table; and
the three dimensional table and a corresponding inverse three dimensional table are stored in a memory location of the graphics module.

11. A method of operating a display system comprising:
generating a first calibration image comprising a plurality of illuminated points on a display surface by sequentially providing a first display source with a plurality of input values;
measuring an output energy value of the first calibration image at the display surface at one or more output wavelengths for the input values provided to the first display source;
generating a normalized response function of the first display source for each output wavelength, wherein the normalized response functions of the first display source correspond to the measured output energy values of the first display source for the provided input values;
generating a first response function comprising one or more of the normalized response functions of the first display source; and
generating a first image at the display surface by providing corrected first image input values to the first display source, wherein the corrected input values correspond to a desired output energy value of the first display source at one or more illuminated points of the first image based at least in part on a plurality of first image input values, the first response function and an attenuation value.

12. A method as claimed in claim 11 wherein the method further comprises:
generating a second calibration image comprising a plurality of illuminated points on a display surface by sequentially providing a second display source with a plurality of input values;
measuring an output energy value of the second calibration image at the display surface at one or more output wavelengths for the input values provided to the second display source;
generating a normalized response function of the second display source for each output wavelength, wherein the normalized response functions of the second display source correspond to the measured output energy values for the provided input values;
generating a second response function comprising one or more normalized response functions of the second display source; and
generating a second image at the display surface by providing corrected second image input values to the second display source, wherein:
the first display source and the second display source are configured such that at least a portion of the first image overlaps at least a portion of the second image in an overlap region of the multiple-display image, wherein each illuminated point within the overlap region of the multiple-display image comprises a first image contribution and a second image contribution; and
the corrected second image input values correspond to a desired output energy value of the second display source at one or more illuminated points of the second image based at least in part on a plurality of second image input values, the second response function and the attenuation value such that the first image contribution and the second image contribution combine to provide a desired output energy value at each illuminated point within the overlap region of the multiple-display image.

13. A method as claimed in claim 12 wherein the method further comprises, for one or more illuminated points of the multiple-display image:
transforming the first image input values for each illuminated point within the overlap region into output response values of the first display source in accordance with the first response function, and transforming the second image input values into output response values of the second display source in accordance with the second response function;
applying the attenuation value to the output response values of the first and second display sources; and
deriving the corrected input values of the first display source using the attenuated output response values of the first display source by applying an inverse first response function, and deriving the corrected input values of the second display source using the attenuated output response values of the second display source by applying an inverse second response function.

14. A method as claimed in claim 11 wherein each output wavelength comprises a range of wavelengths centered on a base wavelength.

15. A method as claimed in claim 11 wherein the measurement device is configured to capture the output energy values at a first output wavelength, a second output wavelength and a third output wavelength.

16. A method as claimed in claim 15 wherein:
the first output wavelength comprises a range of wavelengths centered on a red base wavelength;
the second output wavelength comprises a range of wavelengths centered on a green base wavelength; and
the third output wavelength comprises a range of wavelengths centered on a blue base wavelength.

17. A method of operating a display system comprising a first display source and a second display source, the method comprising:
generating a first image comprising a plurality of illuminated points on a display surface;
generating a second image comprising a plurality of illuminated points on the display surface, thereby generating a multiple-display image comprising the first and second images, wherein at least a portion of the first image overlaps at least a portion of the second image in an overlap region of the multiple-display image such that each illuminated point within the overlap region of the multiple-display image comprises a first image contribution generated by the first display source and a second image contribution generated by the second display source;
transforming first image input values for one or more illuminated points of the first image within the overlap region into output response values of the first display source, and transforming second image input values for one or more illuminated points of the second image within the overlap region into output response values of the second display source;
deriving corrected first image input values corresponding to the illuminated points of the first image within the overlap region from the output response values of the first display source, and deriving corrected second image input values corresponding to the illuminated points of the second image within the overlap region from the output response values of the second display source; and
controlling the first and second display sources to display the multiple-display image by applying the corrected first image input values and the corrected second image input values such that the first image contribution and the second image contribution combine to provide a desired output energy value at one or more illuminated points within the overlap region of the multiple-display image.

18. A method as claimed in claim 17 wherein the method further comprises:
generating a first calibration image comprising a plurality of illuminated points on a display surface by sequentially providing the first display source with a plurality of calibration input values;
generating a second calibration image comprising a plurality of illuminated points on a display surface by sequentially providing the second display source with the plurality of calibration input values;
measuring an output energy value of the first and second calibration images at the display surface at one or more output wavelengths for each of the input values provided to the first and second display sources;
generating a normalized response function of the first and second display sources for each output wavelength, wherein each normalized response function of the first and second display sources corresponds to the measured output energy values of the first and second display sources for the provided input values; and
generating a first response function comprising one or more normalized response functions of the first display source and a second response function comprising one or more normalized response functions of the second display source.

19. A method as claimed in claim 18 wherein the method further comprises applying an attenuation value to the output response values of the first and second display sources for each illuminated point within overlap region.

20. A method as claimed in claim 19 wherein:
the first image input values are transformed into the output response values of the first display source in accordance with the first response function;
the second image input values are transformed into the output response values of the second display source in accordance with the second response function;
the corrected first image input values are derived from the attenuated output response values of the first display source by an inverse first response function; and
the corrected second image input values are derived from the attenuated output response values of the second display source by an inverse second response function.
